(19) United States
(12) Patent Application Publication
(10) Pub. No.: US 2007/0073594 A1
(43) Pub. Date: Mar. 29, 2007

(54) E-commerce infrastructure and transaction system to commoditize unutilized, and underutilized assets & resources and excess capacity, via sharing or bartering arrangements transacted throught the econoshare system invention

(76) Inventor: Ethel Schwartz, Brooklyn, NY (US)

Correspondence Address: Wilson Daniel Swayze, Jr, 3804 Clearwater Ct., Plano, TX, 75025, US

(21) Appl. No.: 11/292,478

(22) Filed: Dec. 2, 2005

Related U.S. Application Data
(60) Provisional application No. 60/720,207, filed on Sep. 23, 2005.

(51) Int. Cl. G06Q 30/00

(52) U.S. Cl. 705/26

(57) ABSTRACT

A method for sharing resources between an owner and a sharer including forming a list of profiles that described the resource, displaying the list of profiles, determining from the list of profiles a profile of a resource that will satisfy a requirement of either the sharer or the owner, forming direct communication between the owner and sharer and sharing said resource between the owner and the sharer for a cost.

### PRIORITY

The present invention claims priority under 35 USC section 119 and based upon provisional application Ser. No. 60/720,207 filed on Oct. 23, 2005.

### BACKGROUND OF THE INVENTION

Under utilization of business resources exist in many segments, of our economy and across a broad spectrum of commerce. This underutilization or inefficient utilization of resources is counterproductive to market efficiency on a whole and in particular adversely affects the profitability of individual companies. Efficient markets optimally require full or near full utilization of resources in order to minimize the expense of these resources and to maximize the return on investment for such resources, which directly affect the profitability of the companies involved with these resources.

The use of the computer and the Internet for business, referred to as e-commerce, has grown significantly over the several years. This e-commerce has increased the ability for potential buyers to gain access to potential sellers without the need to physically enter the seller's establishment. Additionally, the use of the computer and the Internet has not eliminated the need for resources that businesses require in order to produce products for the sellers and the buyers. The need for these resources and the actual resources available may not be in balance. A particular business's need for a particular resource at a particular time may outweigh the actual resources available to that particular business, resulting in a loss of profits that could have resulted from the sale of additional products and that could have been generated if the resources had been available. Alternatively, if the actual resources owned or controlled by a particular business exceeds the need for those resources such unutilized resources fail to generate a return on its cost thereby adversely affecting the Company's net results In both cases, inefficiencies result and costs increases, resulting from the imbalance.

Additionally, the demand for a product changes as a result of many factors including the normal business cycle. These changing demands result in changes in the required resources.

Businesses that require highly expensive equipment such as rigging, scaffolding, construction equipment, heavy machinery, invest heavily into equipment frequently through financing or leasing arrangements with adherent financing charges that must be paid timely. The payment of financing or leasing charges becomes especially burdensome when such equipment is idle and not generating revenues.

Oil & Gas as well scaffolding and construction industries undergo business cycles conducive to down time in which certain equipment is not being utilized during portions of the business cycle.

Currently, there is no centralized infrastructure for the owner of a resource to commoditize the resource by finding and identifying a potential sharer of the resource thereby, sharing the resource and the cost of the resource which pays a portion of the expenses for the owner and generates additional revenue as a result of the sharing of the resource. As a consequence of the lack of this centralized infrastructure, a broad segment of industries have resources that are not fully utilized and stand idle instead of being productive and benefiting the owner of the resource and a potential sharer of the same resource.

This need is illustrated by one recent study by Salary.com and America Online that shows that ‘goofing off’ at work costs and US companies an estimated $759 billion each year with the main reason being given by the survey participants for their wasted time including ‘not enough work to do’ (33.2%). Based on these figures, the market for office resource sharing alone is $252 billion.

### SUMMARY OF THE INVENTION

A Sharing transaction with a potential Sharer of such equipment during the idle periods, harnesses the “sleeper assets” into productive assets while defraying a portion of such financing costs.

The Sharer of such resources can potentially increase their productivity and expand their business as it can fill its peak time equipment requirements by tapping into the EconoShare market place, thus streamlining asset expenditures by efficient utilization of its resources.

By introducing an auction and discovery marketplace for excess resources and capacity, EconoShare enables commodotizing these “resources” and adding revenue stream for firms willing to share excess capacity with a potential Sharer of such “resource”, thereby sharing the resource and its cost. Consequently the “Owner” of such resource generates new revenues from otherwise sunken costs which materially affect their bottom line. Furthermore, by offering their excess capacity at low marginal rates, a potential “sharer” of such resource benefits, as he would otherwise require purchasing a similar resource for full price, that would only be partially utilized.

The present invention is a method and apparatus to commoditize underutilized assets and resources including excess capacity. The present invention is a comprehensive efficient oriented method and apparatus to create a marketplace to promote the efficient utilization of resources by providing a marketplace for underutilized resources as determined by the owner and to be used by a sharer as a shared resource resulting in the cost benefits to both the owner and sharer. The present invention will serve a varied and diversified segment of the economy, stretching across many industries with a theme of matching excess capacity and resources with a potential sharer. The present invention is not limited to any industry but is particularly helpful for industries with business cycles that have excess resources and capacities which can benefit from the present invention.

The present invention is not limited to any type of industries and includes but is not limited to industrial equipment such as rigging, scaffolding equipment, machinery, specialized vehicles, factory capacity, manufacturing capacity, logistics, and conveyor systems etc. Additionally, the teachings of the present invention can be applied to assets such as excess storage facilities, commodities, specialized infrastructures, clean rooms, call centers and other types of infrastructures providing other types of capacities.

The teachings of the present invention are not limited to fixed assets but includes excess skills capacity of services of individuals for example freelancers, professionals, individuals or others small businesses. The present invention is applicable to professionals who have very specialized capacities and may have excess capacity for additional work in their specialized fields. The present invention will operate as a skills supermarket for freelance professionals and individuals to offer their specialized skills and capabilities of these professionals and individuals to potential clients who are seeking these specialized skills and capabilities in the same fashion as the underutilized assets and capacities such as equipment and other resources are offered to individuals seeking use of these underutilized assets and capacities thereby attaining potentially full utilization of these assets and skills for the owner and cost savings for the sharer.

The present invention is not limited to a business to business sharing arrangement, but can also be implemented in a consumer markets for sharing of excess capacity such as vehicles, lawn mower equipment, vacation homes, nannies and housekeepers, and any other asset or capability. The present invention includes a central host computer that may be linked by a network such as the Internet to remote client terminals which may be personal computers and which can be accessed by either the owners of the resources or sharer of the resources. In this way, the owner of a resource that is not fully utilized or the owner of the resource having excess capacity may list the resource and submit to the host computer a profile including the nature of the resource for example the type of resource along with more detailed information of the resource, logistics which includes the time duration that the resource is available and a minimum or opening price. The profile may include a profile number which should be unique to the system to identify the profile, and the system may be operated as an auction and may be operated similar to the auction at eBay.

### BRIEF DESCRIPTION OF THE DRAWINGS

The invention may be understood by reference to the following description taken in conjunction with the accompanying drawings, in which, like reference numerals identify like elements, and in which:

FIG. 1 illustrates a computer system for implementation of the Econoshare system;

FIG. 2 illustrates details of the computer system

FIG. 3 illustrates a method of examining a profile;

FIG. 4 illustrates a method of placing a bid.

### DETAILED DESCRIPTION

The following definitions are presented with the understanding that they are to be used to illustrate the present invention and not to in any way limit the scope of the present invention.

A resource is any equipment, infrastructure, human capacity or other asset. A sleeper asset is a resource that is not being fully utilized or is an excess asset or capability that is not currently generating revenue, other consideration or benefit. An owner is a person or entity that owns or controls the resource. A sharer is a person or entity requiring a resource and willing to share the resource and pay the cost or other consideration for sharing the resource with the owner. An asset is a commodity or other resource of value. A list is a listing to be displayed on for example a remote client terminal where the sharer can access the listing and allows the owner to submit the resource to be available for sharing. A profile is a complete description of the resource available for sharing. The profile number is a number that is assigned to identify the profile. Membership fees are the fees paid by each owner or sharer submitting or accessing a profile. A listed owner is an owner who is a member of the Econoshare Transaction system which is the subject of the present invention, and a listed sharer is a sharer who is a member of the Econoshare system. A global is a resource that can be shared globally; a national is a resource that can be shared nationally; and a local is a resource which for logistic reasons can only be shared locally. The present invention includes a central host computer such as a network of personal computers that are connected through the Internet or any other suitable interconnection, and the personal computer is operated by either the owner of the resource or the sharer who wish is to obtain use of a portion or a sharer of the resource. The owners of the resource may list the resource with a personal computer so that it can be accessed over the network of personal computers. The owner submits a profile for the resource including the nature of the resource that the owner is seeking to share including a detailed description of the resource, logistics and availability details such as time duration and the starting time when the time duration begins for sharing the resource and the minimum or opening price for the resource. The profile should be identified by a profile number which can be used to identify and access the profile. The cost of sharing the resource could be a fee which is set by the owner or could be determined by an auction system similar to eBay or transacted in an over the counter negotiated transaction between the owner and sharer. The profile attempts to describe the nature of the resource that the owner is seeking to share with the sharer including a detailed description of the resource including logistics, availability of requirements such as time duration and when the resource is available and a price.

A sharer should have many ways in which to review the available resources through the corresponding profile. The profiles could be sorted by predetermined categories such as office space, warehouse storage, professional services such as drafting or legal services and equipment just to name a few. Alternatively, the profiles could be sorted geographically for example global, national or local categories which depend on the type of resource and its logistic requirement. These categories result in the ability of the sharer to quickly and easily identify a resource that meets the requirements of the sharer. Once the sharer identifies a resource or category that meets the requirements of the sharer, then, it is a matter of determining the price or cost of the resource which may be set by a fixed cost, barter or auctioned off in a system similar to eBay or transacted in negotiated transaction between the owner and sharer. With the present invention, it is possible for the sharer to list the resource that the sharer would like to obtain, and as a result, potential owners can see the listed resource and determine if the owner has a resourcein which the sharer would have an interest. With the present invention, the owner and the sharer may enter into direct contact with each other so that a cost can be negotiated and additional information can be obtained. With sharing, there is no transfer of ownership of the resource. The owner only transfers the right to use the resource for a predetermined period of time to the sharer. The cost to the sharer defers a portion of the expenses of the resource and/or generates additional revenues that would not have been generated otherwise.

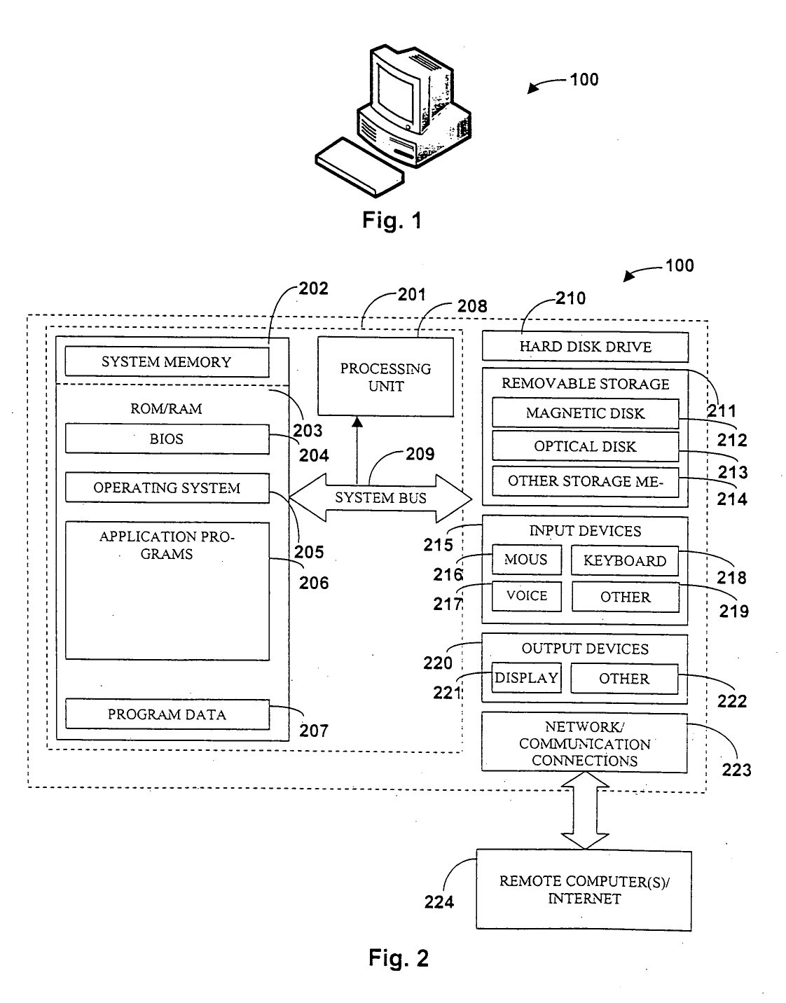

FIG. 1 illustrates a personal computer 100 that may be used by the owner or the sharer in order to use the Econoshare system in accordance with the teachings of the present invention.

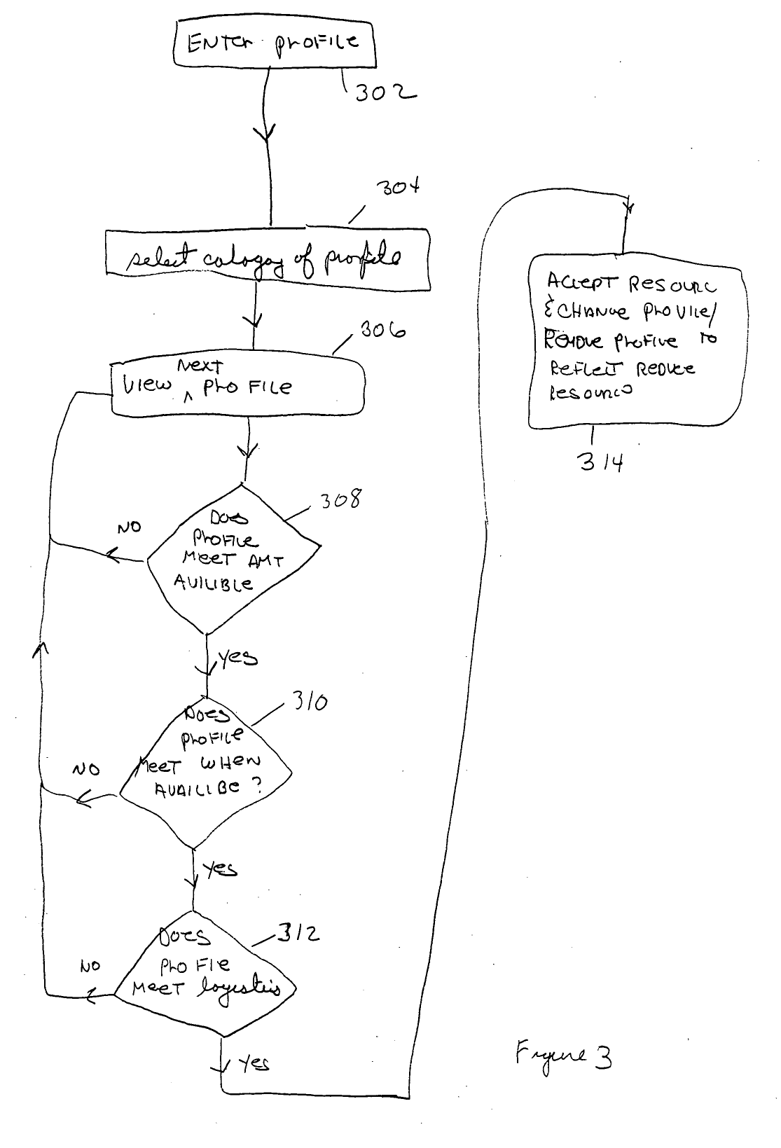

FIG. 2 illustrates details of the personal computer 100 as shown in FIG. 1. The personal computer 100 includes input devices 215 in order to input information such as the profile into the personal computer 100. The input devices 215 include a mouse 216, a voice input 217, a keyboard 218 or other input device 219. The input device 215 communicates with the processing unit 208 by the system bus 209. The input device 215 can accept information relating to the resource for example profile information. The personal computer 100 includes output devices 220 in order to output information to a user for example to the owner or to the sharer. The output devices 220 include a display 221 or other output device 222 to display information to the owner or to the sharer. The output devices 220 are connected to the processing unit 208 by the system bus 209. The personal computer 100 additionally includes components 201 including a hard disk drive 210 in order to store information. The personal computer 100 includes removable storage 211 including a magnetic disc 212, an optical disc 213 and other storage media 214. The personal computer 100 is connected to remote computers via the Internet 224 by network communication connections 223 to allow the owner and share to communicate to each other by the personal computer 100 of the respective owner or sharer. The personal computer 100 includes system memory 202, BIOS 204 and ROM/RAM 203, an operating system 205 and includes application programs 206 such as the program for the Econoshare system by using the program data 207.

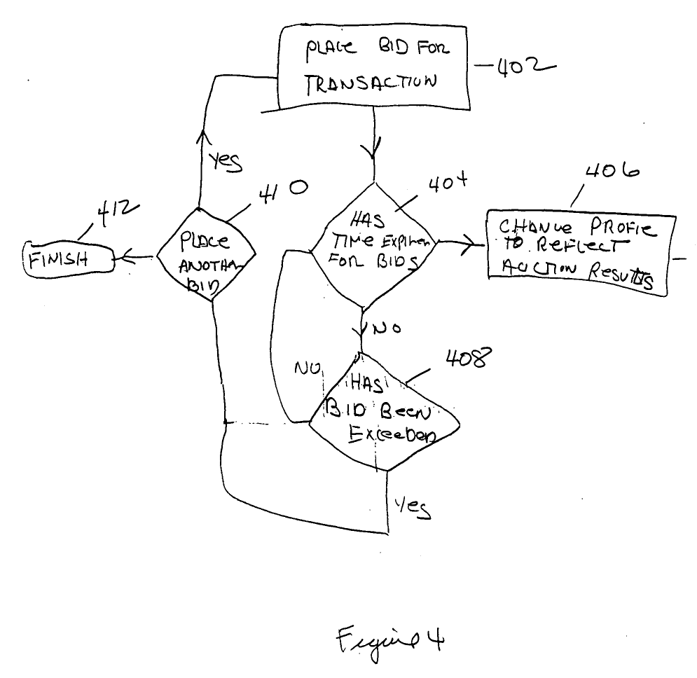

FIG. 3 illustrates the steps that a user for example a sharer would take in order to find if a resource is available. The sharer would access the profiles and determine if a profile exists that matches the need of the sharer. In step 302 the sharer enters the profile by selecting a category of the profiles in step 304, for example oil rigging equipment. The sharer examines the first profile and determines that this profile is inappropriate for the sharer's needs. In step 306, the next profile is viewed by the sharer. Next, in step 308, the sharer determines if the resource of the current profile meets the amount of the resource needed by the sharer. If the current profile does not meet the amount needed by the sharer, then the sharer views the next profile in step 306. If the current profile does meet the amount needed by the sharer, then, in step 310, the current profile is examined to determine when the resource is available. If the time period when the resource is available does not meet the needs of the sharer, the sharer views the next profile in step 306. If the time period when the resource is available does meet the needs of a sharer, then control passes to step 312. In step 312, the sharer determines if the resource meets the logistical needs of the sharer, for example, is the resource available at the location where the need for the resource is located. If the sharer determines that the profile does not meet the logistic needs of the sharer, then the control returns to step 306 to allow the sharer to view the next profile. If the sharer determines that the profile does meet the logistical needs of the sharer and control passes to step 314 where the sharer accepts the resource and changes the profile to indicate the acceptance. The sharer may need to apply other criteria such as cost to determine if the profile meets the needs of the sharer. These other criteria, although not explicitly disclosed, are encompassed by the present invention.

FIG. 4 illustrates one method of determining the cost of the resource. Although many methods are available including the cost being fixed by the owner, FIG. 4 illustrates a method similar to the auction at eBay.

In step 402, a bid is placed by the sharer for the resource. In step 404, the system determines if the time has expired for the bids for this particular resource. If the time has expired, then the top bid is selected as the price for the resource, and if the sharer had placed the top bidder is notified that his/her bid has been accepted and the profile is changed to reflect that the resource is not available in step 406.

In step 404, if the time for bids has not expired, it is determined if the bid has been exceeded with a higher bid. If the bid has not been exceeded then control returns to step 404 to see if the time for bids has been exceeded. In step 408, if bid has been exceeded is determined. In step 410 the sharer decides whether or not to place another bid. If the sharer decides not to place another bid, then control passes to step 412 where the process ends in step 412. However, if the sharer wishes to place another bid, then control passes to step 402 where a new bid is placed.

While invention is susceptible to various modifications and alternative forms, specific embodiments thereof have been shown by way of example in the drawings and are herein described in detail. It should be understood, however, that the description herein of specific embodiments is not intended to limit the invention to the particular forms disclosed.

1) A method for sharing resources between an owner and a sharer, the method comprising the steps of:
forming a list of profiles that described said resource;
displaying said list of profiles;
determining from said list of profiles a profile of a resource that will satisfy a requirement of either said sharer or said owner;
forming direct communication between said owner and sharer; and
sharing said resource between said owner and said sharer for a cost.

2) A method for sharing resources between an owner and a sharer as in claim 1, wherein said resource includes a fixed asset.

3) A method for sharing resources between an owner and a sharer as in claim 1, wherein said resource includes a service.

4) A method for sharing resources between an owner and a sharer as in claim 3, wherein said service includes a professional service

5) A method for sharing resources between an owner and a sharer as in claim 3, wherein said service include specialty skills.

6) A method for sharing resources between an owner and a sharer as in claim 1, wherein said cost is obtained by auction.

7) A method for sharing resources between an owner and a sharer as in claim 1, wherein said cost is obtained by an eBay type auction.

8) A system for sharing resources between an owner and a sharer, the system comprising:
an input device for inputting a list of profiles that described said resource;
a display to display said list of profiles and determining from said list of profiles a profile of a resource that will satisfy a requirement of either said sharer or said owner;
a communication device to establish direct communication between said owner and sharer; and sharing said resource between said owner and said sharer for a cost.

9) A system for sharing resources between an owner and a sharer as in claim 8, wherein said resource includes a fixed asset.

10) A system for sharing resources between an owner and a sharer as in claim 9, wherein said resource includes a service.

11) A system for sharing resources between an owner and a sharer as in claim 1011, wherein said service includes a professional service

12) A system for sharing resources between an owner and a sharer as in claim 10, wherein said service include specialty skills.

13) A system for sharing resources between an owner and a sharer as in claim 8, wherein said cost is obtained by auction.

14) A system for sharing resources between an owner and a sharer as in claim 8, wherein said cost is obtained by an eBay type auction.

15) A method for sharing resources between an owner and a sharer as in claim 1, wherein said cost is obtained by an over the counter negotiated transaction.

16) A method for sharing resources between an owner and a sharer as in claim 15, wherein said transaction is a barter transaction.

17) A system for sharing resources between an owner and a sharer as in claim 8, wherein said cost is obtained by an over the counter negotiated transaction.

16) A system for sharing resources between an owner and a sharer as in claim 17, wherein said transaction is a barter transaction.
